(19) United States
(12) Patent Application Publication
(10) Pub. No.: US 2005/0050681 A1
(43) Pub. Date: Mar. 10, 2005

(54) Magnetic door stop

(76) Inventor: Sheila Lynn Schlitter, Winnetka, IL (US)

Correspondence Address: Sheila Lynn Schlitter, 507 Orchard Lane, Winnetka, IL, 60093, US

(21) Appl. No.: 10/657,643

(22) Filed: Sep. 8, 2003

(51) Int. Cl. E05F 5/02

(52) U.S. Cl. 16/82

(57) ABSTRACT

A magnetic doorstop comprising a magnet to be placed on or near the metal surface of an interleaving knuckle of a door hinge, said magnetic doorstop preferably being shaped in the same arc or other contour as the knuckle, or having another suitable configuration, so as to be held by the magnet in the desired position. As the door to which the hinge is attached opens, the magnetic doorstop will prevent the door from opening beyond the point at which the doorstop comes into contact with the opening door, or with any part of the doorframe, doorjamb or hinge leaves.

### BACKGROUND OF THE INVENTION

1. Field of the Invention

This invention relates to a device used to keep a door from swinging open into walls, furniture and other objects, causing damage to the door or such objects. Prior devices for stopping a door from opening wider than desired have all had disadvantages. They have been designed either to be screwed into a wall or baseboard, in which case they are unattractive, not adjustable and cause damage to the wall or baseboard, or to be inserted onto the door hinge by removing the hinge pin and inserting it through a doorstop and into the hinge. In the latter case, the doorstop is unattractive and damage may occur to a painted hinge when removing the hinge pin. Further, the installation of most previously designed doorstops requires the use of tools.

2. Description of the Related Art

The applicant is aware of the following prior art; however, while the devices described therein may be suitable for the particular purposes which they address, they would not be suitable for the purposes of the present invention as heretofore and hereafter described:

U.S. Pat. No. 5,581,844 to RAHEB, et al. for a door stop discloses an improved door stop comprising a block member secured in a removable manner against a leaf of a hinge on a doorjamb, so as to stop a door from closing completely into the doorjamb thereby preventing fingers of a hand of a person from getting pinched and injured between an edge of the door and the doorjamb.

U.S. Pat. No. 5,836,049 to CHIANG for a doorstop discloses a holder unit fixedly fastened to the floor to hold a magnet, and a strap fixedly fastened to the door to hold an iron plate for being secured to the magnet of the holder unit by a magnetic force of attraction to hold the door in an open position. Also disclosed is a retainer loop coupled to the strap by a slip joint and adapted for hanging on a T-rod of the holder unit to stop the door from escaping out of the open position.

U.S. Pat. No. 5,887,917 to LUCIANA discloses a magnetic door stop including a first section consisting of a magnet secured with a retaining shim mounted on an elongated adjustment screw and a second section consisting of a magnet secured with a retaining shim mounted on an attachment screw. The first section is attached to an interior wall of a dwelling and the second section is attached to the interior door. When the door is opened, the first and second sections contact, thereby magnetically securing the door in an open position.

U.S. Pat. No. 6,588,811 to FERGUSON discloses a reversible magnetic door stop/latch containing a first magnet mounted on or within a door and a second magnet mounted on or within a structure opposing the door, such as a wall, door jamb, door frame or baseboard. When the door is moving towards the opposing structure, the magnetic door stop may be used to prevent the door from slamming into the opposing structure by virtue of the repulsive forces of the magnets. The magnetic door stop/atch may be switched from repulsive configuration to an attractive configuration that holds the door in position.

None of the foregoing prior art doorstop mechanisms, however, solves the problems of providing a doorstop that is easily installed without tools and that is unobtrusive. It is an object of the present invention to solve the foregoing problems. It is a further object of the present invention to provide a doorstop that is suitable for a variety of door, door hinge, and doorframe and doorjamb configurations.

### SUMMARY OF THE INVENTION

To achieve the foregoing and other objects, and in accordance with the purposes of the present invention as embodied and broadly described herein, the present invention preferably employs a magnet to provide a device that functions to prevent a door from opening beyond a desired angle, thereby preventing damage to the door, walls, furniture or other objects. The doorstop of the present invention is positioned on or near the radial surface of an interleaving knuckle of a door hinge.

In one preferred embodiment of the present invention, the magnetic doorstop may be shaped in the same arc or other contour as the individual interleaving knuckle of the door hinge on which the magnetic doorstop will be placed, whereby the entirety or a substantial portion of the inside surface of the magnet will have contact with or be near to the knuckle. The height h of the magnetic doorstop is chosen to be no higher than the height h′ of the individual knuckle on which it is placed so that movement of adjacent knuckles is not restricted by the magnetic doorstop. In other words, preferably the magnetic doorstop remains in a fixed position relative to the knuckle on which it is placed. In alternative embodiments, the contour of the magnet surface need not follow that of the knuckle, and there may be one or more intervening layers of suitable material between the magnet and the knuckle. In another embodiment, the magnetic doorstop of the present invention is placed on a knuckle such that one of its transverse edges abuts the doorframe, doorjamb or one of the hinge leaves attached to the door or doorjamb. The magnetic doorstop can be placed on the surface of any knuckle that is part of the hinge leaf attached to the door, in which case the opening door will be prevented from opening farther once the doorstop comes into contact with the doorframe, the doorjamb or the hinge leaf attached to the doorjamb. Alternatively, the doorstop can be placed on the surface of any knuckle that is part of the hinge leaf attached to the doorjamb; in which case the opening door will be prevented from opening farther once the doorstop comes into contact with the moving door or the pivoting hinge leaf attached to the door. In the preferred embodiment, the maximum angle at which the door can be opened will be determined by the angular position on the knuckle at which the magnetic doorstop is placed, and can be changed simply by moving the magnetic doorstop to a different position on the knuckle. In alternative embodiments, the magnetic doorstop of the present invention has a threaded member or other suitable adjustment means for adjusting the width of the doorstop, whereby the angle through which the door opens before abutting against and being stopped by the magnetic doorstop is determined. In still another embodiment of the present invention, the doorstop is provided with an adhesive surface by which the doorstop is fixedly attached to the knuckle in the desired position.

The present invention has the advantages of providing a simple, inexpensive, inconspicuous and fully and easily adjustable device for preventing a door from opening beyond a desired angle. No tools are required to install the device; it is simply placed on the knuckle, and no alteration of the hinge is necessary. Because the doorstop of the present invention protrudes less than other doorstops, it is more attractive and less noticeable than other doorstops. Also, it is unnecessary to make any hole in the wall, doorjamb, doorframe or floor in order to mount the doorstop of the present invention.

### BRIEF DESCRIPTION OF THE DRAWINGS

The foregoing and other features and advantages of the invention will be apparent from the following, more particular description of a preferred embodiment of the invention, as illustrated in the accompanying drawings.

FIG. 1 shows the placement of the magnetic doorstop of the present invention mounted on a door hinge so as to limit how far the door can open;

FIG. 2 shows a schematic illustration of the magnetic doorstop of the present invention and a hinge on which it can be mounted;

FIG. 3 shows top, front and side views (in FIGS. 3A, 3B and 3C, respectively) of a schematic illustration of the magnetic doorstop of the present invention and of a hinge knuckle 22b of hinge leaf 24b on which it can be mounted;

FIG. 4 shows a perspective schematic illustration of the preferred embodiment of the magnetic doorstop of the present invention (FIG. 4A being a view of the surface to be placed next to a hinge knuckle and FIG. 4B being a view of the surface of the doorstop on the opposite side; and

FIG. 5 shows a schematic illustration of an alternative embodiment of the doorstop of the present invention.

### DETAILED DESCRIPTION OF THE PREFERRED EMBODIMENTS

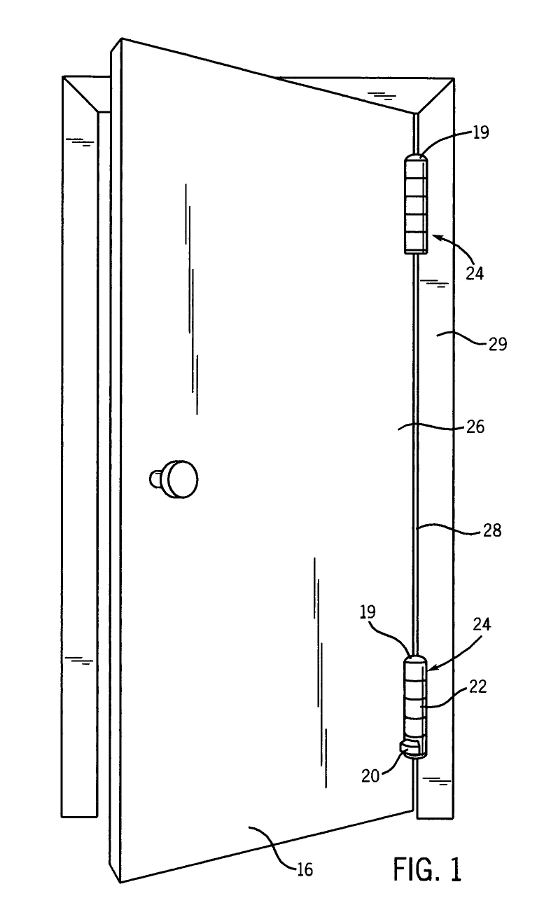

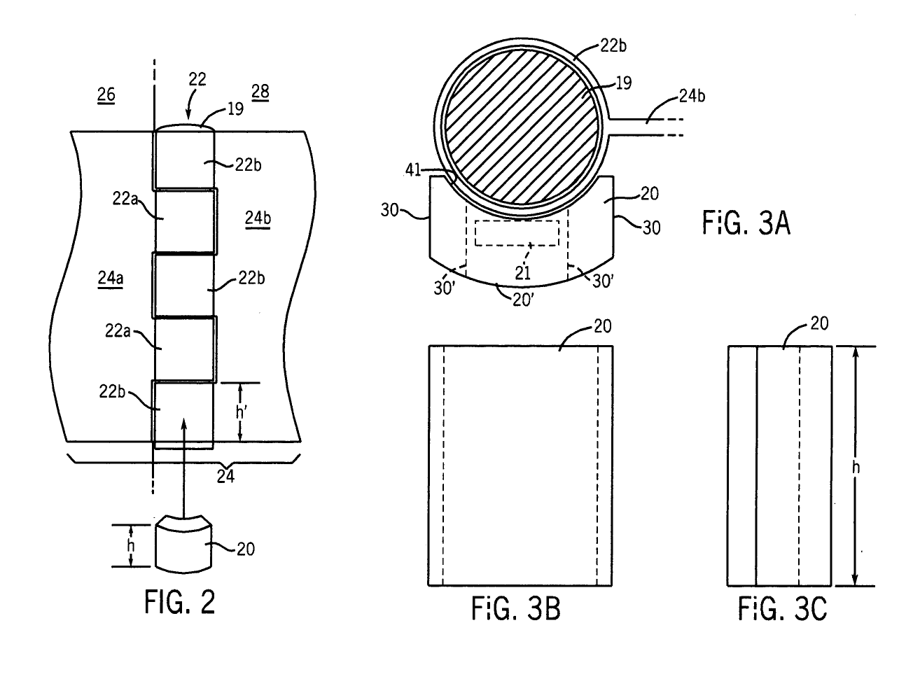

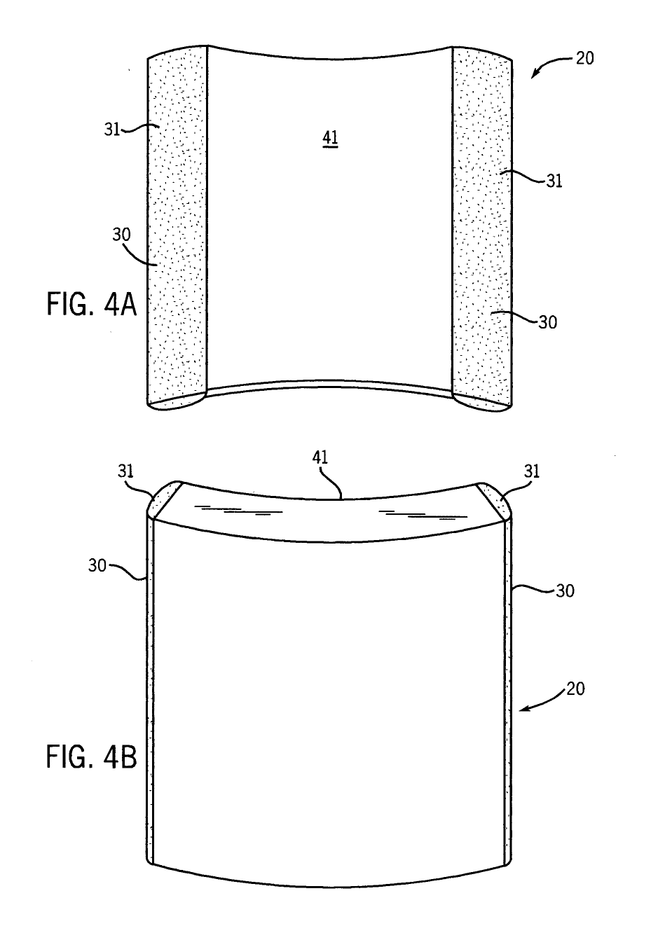

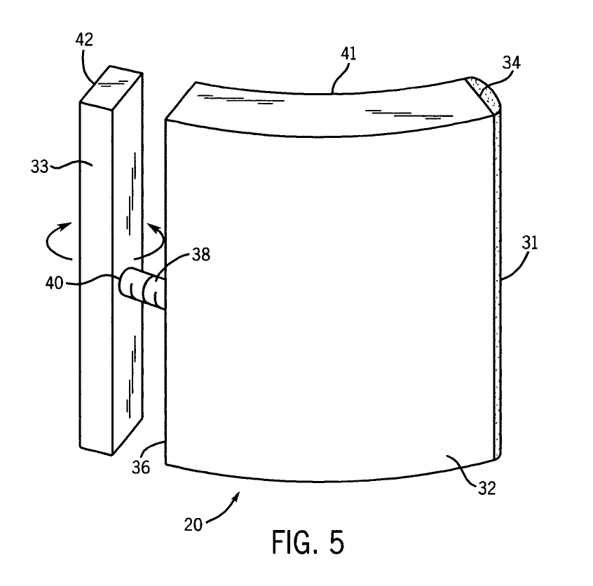

Referring to FIGS. 1-4, magnetic doorstop 20 is mounted on any one knuckle 22a or 22b (each of such knuckles is also referred to as “knuckle 22”) of door hinge 24, one leaf 24a of which is installed on door 26 and the other leaf 24b of which is installed on doorjamb 28. Hinge pin 19 is inserted through knuckles 22a and 22b such that hinge leaves 24a and 24b may pivot with respect to one another. In the preferred embodiment, magnetic doorstop 20 is made of a suitable magnetic material of a sufficient size and having a suitable configuration such that magnetic doorstop 20 is held in the desired location on knuckle 22 by the magnetic force of attraction of magnetic doorstop 20 to the metal knuckle 22. Magnetic doorstop 20, alternatively, may comprise a housing, for example in the configuration of magnetic doorstop 20 or 20′ in FIG. 3A, made of another suitable material with a magnet 21 (as shown schematically in FIG. 3) held within or on such housing. Alternatively doorstop 20 may be made of another suitable, non-magnetic material and held in the desired position on knuckle 22 by an adhesive or other suitable bonding material on surface 41 of magnetic doorstop 20 (see FIGS. 4 and 5). In the preferred embodiment, magnetic doorstop 20 is held in a stationary position on knuckle 22 by the strength of the magnetic force (or, in the alternative embodiment, by the adhesive or other bonding agent). The width of magnetic doorstop 20 between transverse edges 30 (see FIG. 3A) is chosen to be narrow enough to allow the door to open the desired amount and wide enough to restrain the door from opening beyond the desired amount. (A narrower embodiment of the doorstop of the present invention is illustrated by configuration 20′ between transverse edges 30′, indicated by dashed lines, in FIG. 3A). Preferably each transverse edge 30 of magnetic doorstop 20 is partially or completely covered by rubber or other suitable compressible or resilient material 31, as shown in FIG. 4—FIG. 4A being the view of the inside of magnetic doorstop 20 that abuts knuckle 22 and FIG. 4B being the outside of magnetic doorstop 20—so as to cushion the impact between magnetic doorstop 20 and whichever of door 26, doorjamb 28, doorframe 29 or hinge leaves 24a or 24b with which magnetic doorstop 20 comes into contact, and to prevent the foregoing from being marred by contact with transverse edges 30. It is an object of the present invention to provide a doorstop that can be mounted without tools and without requiring any alteration of hinge 24.

The following is a description of alternative embodiments of the magnetic doorstop of the present invention. While the foregoing embodiments and following alternative embodiments are discussed, it should be understood that this is done for illustrative purposes only. A person skilled in the relevant art will recognize that other configurations and arrangements can be used without departing from the spirit and scope of the invention.

The inside surface 41 of magnetic doorstop 20 which abuts knuckle 22 (i.e., surface 41 illustrated in FIGS. 4 and 5) may be covered with a suitable non-scratch material (not shown) of a nature that would prevent any damage to the surface of said knuckle 22.

Preferably, when magnetic doorstop 20 is placed on the surface of knuckle 22, the magnetic attraction of magnetic doorstop 20 will be of sufficient strength to retain magnetic doorstop 20 in stationary contact with knuckle 22 so that door 26 will be prevented from opening farther once transverse edges 30 of magnetic doorstop 20 come into contact with the opening door 26 or hinge leaf 24a attached thereto (in the case of magnetic doorstop 20 being placed on the surface of a knuckle 22b that is a part of hinge leaf 24b attached to doorjamb 28), or with doorjamb 28 or hinge leaf 24b attached thereto or doorframe 29 (in the case of magnetic doorstop 20 being placed on the surface of a knuckle 22a that is a part of hinge leaf 24a attached to door 26). However, if for any reason extra strength or stability is desired, magnetic doorstop 20 can be placed on a knuckle 22 so that one of its transverse edges 30 abuts either, first, in the case of magnetic doorstop 20 placed on the surface of knuckle 22b (attached to doorjamb 28), doorframe 29, doorjamb 28 or hinge leaf 24b attached thereto or, second, in the case of magnetic doorstop 20 being placed on the surface of knuckle 22a (attached to door 26), door 26 or hinge leaf 24A attached to door 26. In such case, adjusting magnetic doorstop 20 to achieve the desired maximum angle beyond which the door cannot be opened can be accomplished by either of two alternatives: (1) providing magnetic doorstop 20 in varying widths; or (2) providing material 31, to be attached to the transverse edges of magnetic doorstop 20, in varying widths.

In one embodiment the magnet 21 contained in magnetic doorstop 20 may be enclosed in a housing (see FIG. 3A) of metal or other suitable material. In such case, the inside surface 41 (see FIGS. 4 and 5) of the housing that abuts knuckle 22 may or may not be covered with a non-scratch and/or non-slip material of a nature that would prevent damage to the surface of said knuckle.

Another alternative embodiment in which magnetic doorstop 20 is easily adjustable with respect to achieving the desired maximum angle beyond which the door cannot be opened is illustrated in FIG. 5. In this embodiment, the magnet (not shown) is enclosed within housing 32. Material 31 is permanently applied to transverse edge 34 of housing 32. Threaded into a nut or other threaded opening (not shown) in housing 32, or threaded into the magnet (not shown) contained in housing 32, will be one end of a threaded shaft 38, which extends outwardly from transverse edge 36. The other end of threaded shaft 38 will be attached to pivot apparatus 40. The other side 42 of pivot apparatus 40 will be attached to member 33, having attached to its edge or side 42 rubber or other suitable compressible or resilient material (not shown), the properties of which may or may not be identical to the properties of material 31, and which may or may not be similar in dimensions to material 31 applied to transverse edge 34. Magnetic doorstop 20 is adjustable by rotating member 33 so as to thread threaded shaft 38 into or out from housing 32 to a desired position. Magnetic doorstop 20 is further adjustable and made more stable by allowing member 33 to pivot about pivot apparatus 40 in a vertical axis, allowing the outermost vertical side of member 33, at the point of its contact with door 26, doorframe 29, doorjamb 28 or hinge leaves 24a or 24b, to pivot so that the maximum surface of such side will make contact with such door, doorframe, doorjamb or hinge leaves.

The inside surface 41 of magnetic doorstop 20 which abuts knuckle 22 may be covered with a material suitable to enhance the adherence properties of magnetic doorstop 20 to the surface of knuckle 22, for example, a non-slip material or an adhesive.

The scope of this invention is intended to encompass any device made from any material that is placed onto the surface of a knuckle of a door hinge and adheres thereto through the use of magnetic force or any material with adhesive properties, for purposes of preventing the door from opening beyond a particular angle.

1. A doorstop comprising a magnet having first and second transverse edges, said magnet being adapted to be placed on a knuckle of a door hinge so as to limit the angle through which the door to which the hinge is mounted can be swung open, the magnet limiting the maximum angle that the door can open by being interposed between the opening door or hinge leaf attached thereto and the doorframe, doorjamb or hinge leaf attached thereto.
